(19) United States
(12) Patent Application Publication
(10) Pub. No.: US 2007/0098487 A1
(43) Pub. Date: May 3, 2007

(54) Pole adaptor to a multi-task extension pole

(76) Inventor: Hyung Soo Kim, Rowland Heights, CA (US)

Correspondence Address: LAW OFFICES OF MYOUNG K. LEE, 2677 NORTH MAIN STREET, SUITE 320, SANTA ANA, CA, 92705, US

(21) Appl. No.: 11/264,611

(22) Filed: Oct. 31, 2005

(51) Int. Cl. F16B 7/10

(52) U.S. Cl. 403/109.1

(57) ABSTRACT

A pole adaptor for connecting and disconnecting a multi-task pole with an attachment tool provides a secure connection and preserves the useful life of the multi-task pole. The adaptor embodies an elongated cylindrical housing having a first open end with two clip holes, a mid-section, and a second open end having four tab holes. The first open end forms a receptacle for the multi-task pole and an alignment with the clip holes for securely attaching the pole adaptor. The second open end forms a receptacle for the attachment tool handle and allowing the handle tabs to connect with two tab holes therein. Four tab holes are provided at the second open end for continued use of the adaptor if two tab wholes wear out.

### BACKGROUND OF THE INVENTION

1. Field of the invention

The present invention relates to a pole adapter, more particularly, is designed to protect the multi-task extension pole attachment end so that the useful life of the multi-task extension pole may be extended.

2. Description of Prior Art

Multi-task extension poles have been used to extend the reach of a variety of hand-held attachment tools. For example, extension poles are used to extend the reach of mop heads, drywall sanding implements, light bulb removing implements, pool skimming implements, window washing implements, and many others.

People over the years tried to improve the connection between attachment tools and extension pole. Easy to attach and to remove, and firm and releasable connection have been an ultimate goal to the inventors in this specific field of the art. For that reason, most prior arts mainly have been focused on locking mechanism on coupling assembly to improve these qualities and they are shown as follows: U.S. Pat. No. 5,385,420; U.S. Pat. No. 6,497,007; U.S. Pat. No. 6,553,628B2, and U.S. Pat. No. 4,406,559.

The usefulness of multitask extension poles is commonly accepted fact, generally, most of multitask extension poles are formed from extruded aluminum sheets that are rolled into a cylindrical shape for its lightness. Aluminum is not strong enough to withstand the constant locking and unlocking activities of attachment tools. Because of its inherent characteristic of its softness and due to torque applied during normal use of the device, the clip holes and tab holes wear out and the quality of secure connection between the attachment tool and the extension pole deteriorates thereby making the extension pole prematurely useless. As a result otherwise useful extension poles soon are to be replaced with another extension pole. These aluminum poles are not cheap, costing about $40 per unit.

Accordingly, there is a need for a durable extension pole that provides an added protection from continuous locking and unlocking of attachment members, and to extend the useful life of the extension pole. The present invention provides a strong and cost-effective device to protect extension pole and extends the useful life therein.

### SUMMARY OF THE INVENTION

The pole adapter of the present invention is embodied in a strong and cost-effective adaptive devise to be attached to a multi-task pole that is typically used for reaching high or distant places such as for swimming pool cleaning. The present invention is operable to prolong the useful life of the multi-task pole thereby reducing investment cost and being environmentally friendly. It is further operable to easily connect and disconnect the multi-task pole with various interchangeable attachment tools. Most preferably, the pole adapter provides a universal assembly that securely connects to various attachment tools that are commercially available.

It is still further object of this invention to provide a pole adapter that can releasably connect an implement to an outer diameter of an extension pole and, thus allows the use of either hollow or solid extension poles.

It is another object of this present invention to provide a pole adapter that is inexpensive, easy to use, and easy to manufacture by conventional methods at high production rate. The pole adapter is made of a non-corrosive hard material, such as stainless steel, other metal materials including aluminum, even any durable plastic or polyethylene material.

In accordance with these and other objects evident from the following description of the preferred embodiment, the present invention, the pole adapter includes a housing being hollow and having a elongated cylindrical receptacle comprising a first open end, second open end, mid section, a tapered neck, at least two clip holes and a plurality of tab holes.

The first open end is to receive the extension pole attachment end which is a connecting portion of the extension pole to be protected. Simply, a part of housing toward first end is to create a space for the extension pole attachment end. Therefore first outer diameter should be slightly larger than the diameter of the extension pole. The extension pole is inserted through the first open end toward the mid section by simply positioning to align the clip holes on the pole adapter and the holes on the extension pole attachment end . A binding screw will be inserted through the aligned clip holes for a firm and releasable connection; thereby the extension pole is ready to be connected to the hand-held attachment tool.

The first open end and the second open end are being distinguished by the tapered neck. A useful function of the tapered neck is to reduce the diameter of the second open end to accommodate the conventional tool handle whose diameter is generally slightly less than the diameter of the extension pole. Conversely, the tapered neck can also used to increase the diameter of the second open end if the diameter of the tool handle is larger than the diameter of the extension pole.

The second open end is to receive an attachment tool handle so that the tool may be physically connected to the extension pole for its intended use. The tool handle is inserted through the second open end toward the mid section by gently maneuvering the handle so that the two tabs on the handle of the implement are to be aligned with the tabs holes on the pole adaptor for locking thereby the tool implement is firmly and releasably connected to the extension pole.

The length of the pole adapter may be predetermined according to the user's specific needs, however, not to add unnecessary weight to the extension pole, it should only be adequately long enough to house the extension pole attachment end to be protected and connecting portion of the attachment tool handle (attachment tool handle end). For general purpose use described earlier, based on commercially available extension poles and various attachment tools: the pole adaptor may be about 6¼ inches long; the distance between first open end and the mid section is about 4¼ inches; the diameters of the first open end and the mid section are equal, measuring about 1¼ inches; the diameter of the second open end is about 1 3/16 inches. The distance between the tab hole and the second open end is about ⅜ inches, the distance between the clip hole and the first open end is about ⅜ inches, and the diameter of the tab hole and the diameter of the clip hole are about same and approximately ¼ inch. These dimensions of the present embodiment are used as a model. Thus, the dimensions may vary depending upon the size of the extension pole and the tool for a specific need.

### BRIEF DESCRIPTION OF THE DRAWINGS

FIG. 1 is a perspective view of a housing of the pole adapter.

FIG. 2 is a partial exploded perspective view of an exemplary embodiment of the pole adapter according to the present disclosure in use with an extension pole and an attachment tool.

FIG. 3 is a perspective view of the multi-task extension pole attachment end enveloped by the pole adapter.

FIG. 4 is a perspective view of the attachment tool as connected to the extension pole via pole adapter.

FIG. 5 is a side section view of the pole adapter employed in a preferred embodiment of the present invention.

FIG. 6 is an elevated view of a first open end of the pole adapter.

FIG. 7 is an elevated view of the second open end of the pole adapter.

FIG. 8 is an elevated view of the mid section of the pole adapter.

### DESCRIPTION OF THE PREFERRED EMBODIMENT

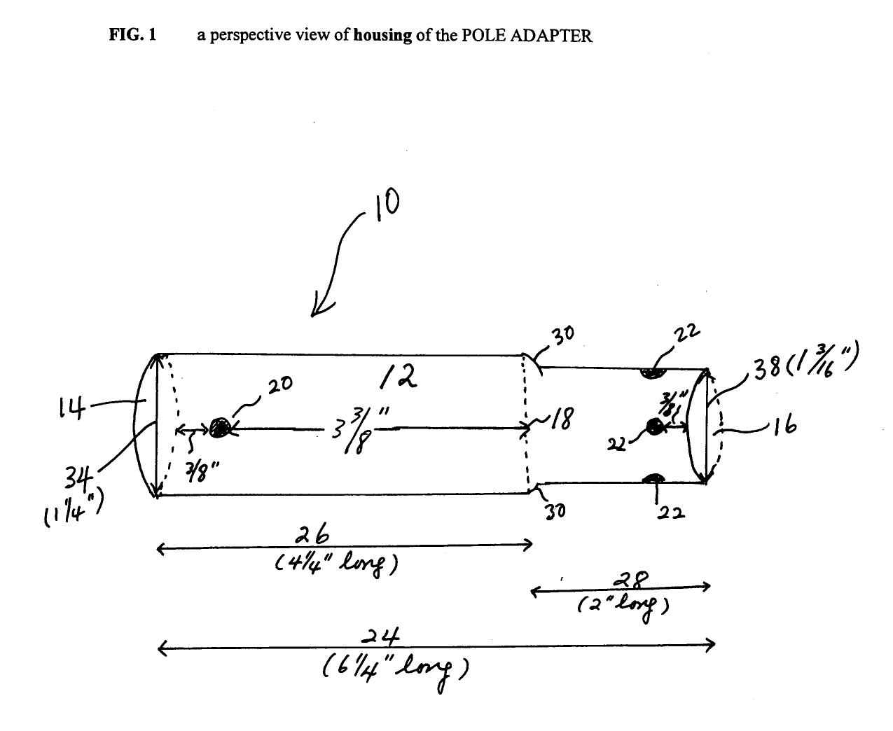

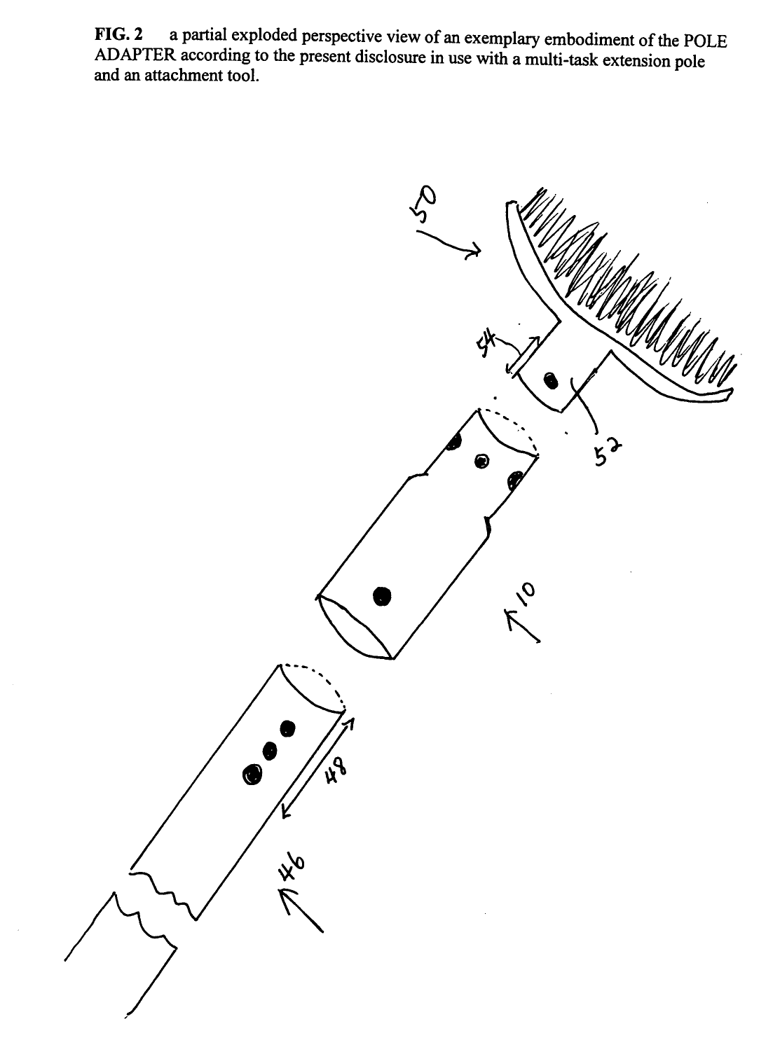

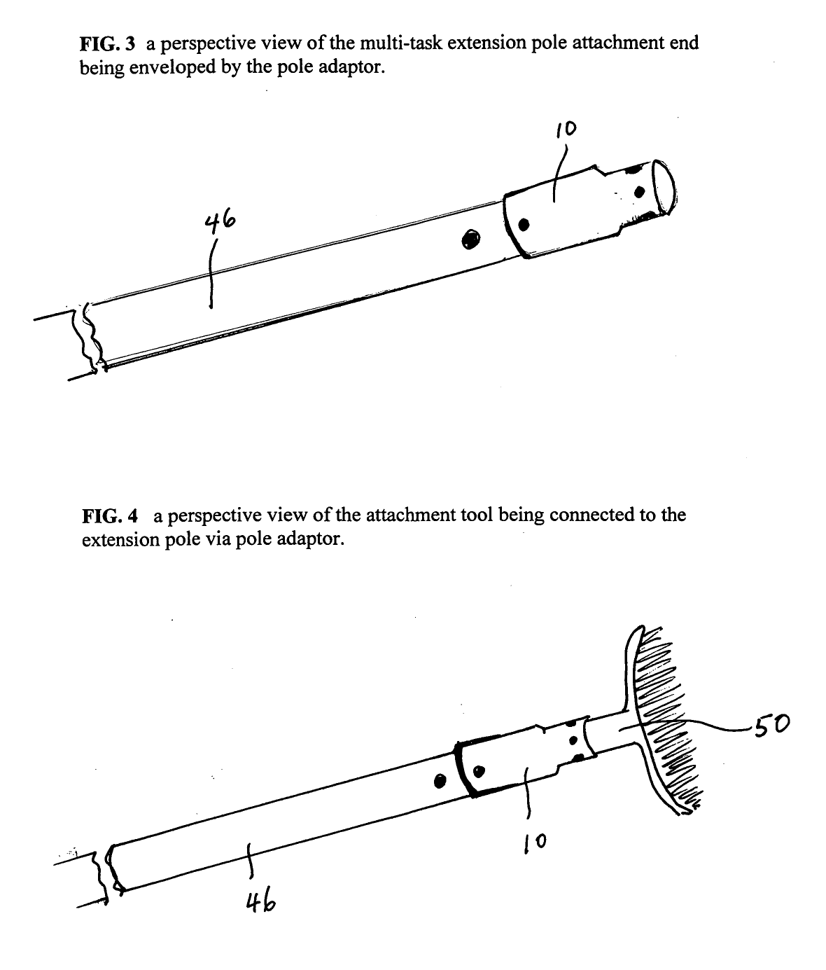

FIG. 1 illustrates the multi-task pole adapter of the present invention. The pole adapter 10 is an elongated cylindrical housing 12 having a first open end 14, a mid-section 18, and a second open end 16. As shown in FIGS. 2-4, the pole adaptor 10 is the central element in an assembly that includes a multi-task extension pole 46 and an attachment tool 50. Multi-task extension poles typical use includes window cleaning, swimming pool cleaning, wall cleaning, floor mopping and many more.

In a preferred embodiment, the pole adapter 10 is configured as a hollow and cylindrical receptacle that releasably connects the pole adapter first open end 14 with the multi-task extension pole attachment end 48 and also adaptively connects the pole adapter second open end 16 with the attachment tool handle 52, therein forming a secure and durable assembly that will meet the user's desired usage. The attachment tool 50 can be a paint roller, a window cleaning tool, a pool brush, or a pool vacuum tool.

Typically, the multi-task extension pole 46 is made of rolled aluminum for its light weight characteristic. The pole adapter 10 is preferably made from strong non-corrosive material to strengthen the pole adapter assembly and reduce the deteriorating effects of continuous connecting and disconnecting of the attachment tool 50. In normal use, the connecting end of multi-task extension pole attachment end 48 becomes worn, therein causing the tab holes 22, or clip holes 20, to become deformed via material expansion, resulting in an unsecured connection of the attachment tool 50. This wearing and tearing of the multi-task extension pole attachment end 48 renders the extension pole useless and requires the user to purchase another extension pole.

In a preferred embodiment, the pole adapter 10 is made of non-corrosive hard material, such as stainless steel or other metal materials. However, those skilled in the art will appreciate the strength and durability that other hard, non-corrosive materials will provide to the pole adaptor 10, such as stainless steel, metals, durable plastics and polyethylene material.

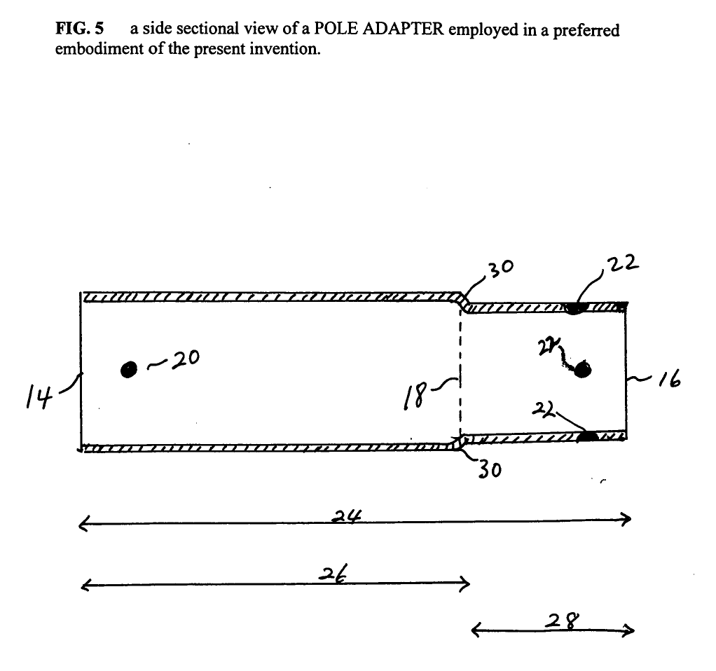

Referring to FIG. 5, the pole adaptor 10 of the present invention further includes points of connection at the first open end 14 and the second open end 16. At the first open end 14 there are at least two clip holes 20, which are points of connection. The clip holes 20 located at opposite sides of the cylindrical housing 12 near the first open end 14 are configured to align with similarly placed clip holes 20 on the multi-task extension pole attachment end 48. Once the clips holes 20 on the pole adapter 10 are aligned with the holes on the extension pole 46, the aligned holes are fastened together by inserting a binding screw thereby forming a secure connection between the pole adapter 10 and the extension pole 46. The binding screw is commercially available in hardware stores and the size is determined by the size of the clip hole in a preferred embodiment.

The pole adapter second open end 16 includes four equally spaced points of connection, herein referred to as tab holes 22. The tab holes 22 are configured for alignment and connection with two tab holes located on an attachment tool handle 52. Most attachment tool handles are universally designed to provide two outwardly biased locking tabs that connect with the multi-task extension pole 46 when the tab holes and locking tabs are positioned. The pole adapter 10 of the present invention is configured to receive a whole or portion of attachment tool handle 52 (i.e. attachment tool handle end 54) and connect thereon via two universally positioned tab holes. Those skilled in the art will appreciate that the pole adapter includes four tab holes 22 on the second open end 16 so that a second set of holes may be used if the first used tab holes become deformed or worn out. Further, those extra pair of the tab holes 22 when not in use may be used as draining holes.

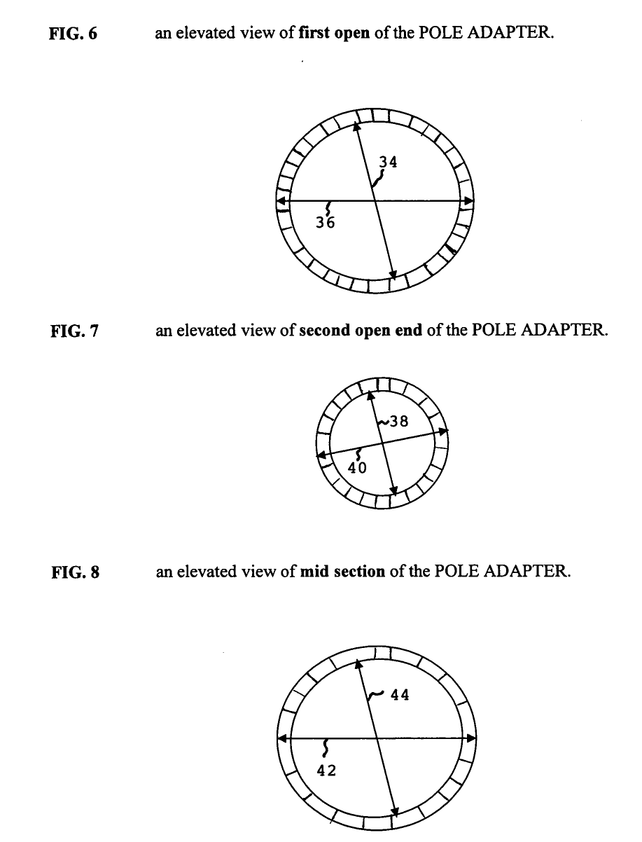

As shown in FIG. 5, the cylindrical housing 12 of the pole adapter 10 further includes a longitudinal edge 24 that is divided by a first longitudinal edge 26 that encompasses the first open end 14, and a second longitudinal edge 28 encompassing the second open end 16. The first longitudinal edge 26 and the second longitudinal edge 28 are distinguished at the pole adapter mid-section 18 by a reduced diameter. The pole adapter first open end 14 is configured with a first inner diameter 34 and a first outer diameter 36 (see FIG. 6) configured to releasably receive the multi-task extension pole attachment end 48 that is cylindrical. In operation, the multi-task extension pole 46 is inserted into the pole adapter 10 via first open end 14 towards the mid-section 18. Similarly, the pole adapter 10 having second open end 16 is configured with a second inner diameter 38 and a second outer diameter 40 (see FIG. 7) configured to releasably receive the cylindrical attachment tool handle 52. The first open end 14 and the second open end 16 are distinguished by the tapered neck 30. A useful function of the tapered neck 30 is to reduce the diameter of the second open end to accommodate the attachment tool handle 52 whose diameter is less than the diameter of the extension pole.

The pole adapter longitudinal edge 24 is in the range of 6 inches to 7 inches and the first longitudinal edge 26 is approximately twice the length of the second longitudinal edge 28. As previously stated, the pole adapter 10 is configured to envelope both, the multi-task extension pole attachment end 48 at the first open end 14 and the attachment tool handle 52 at the second open end 16. By way of example as shown in FIG. 1 and FIG. 5, the preferred embodiment of the pole adapter of the present invention has: a first inner diameter 34 and the diameter of the mid section that are equal, measuring about 1¼ inches, a second inner diameter 38 is about 1 3/16 inches, a first longitudinal edge 26 is about 4¼ inches, a second longitudinal edge 28 is about 2 inches, the distance between mid section 18 and the clip hole 20 is about 3⅜ inches, the distance between the second open end 16 and the tab holes 22 is about ⅜ inches. Accordingly, the previously stated measurements are submitted by way of example and actual measurements of the pole adaptor may vary depending upon sizes of extension poles and attachment tools.

The pole adapter mid-section 18 is configured to form a tapered neck 30 where the housing wall 32 transitions from the first outer diameter 36 and second outer diameter 40. The pole adaptor wall 32 has a thickness approximately 1/16 inches however the thickness may vary depending on the pole adaptor 10 materials.

While the specification describes particular embodiments of the present invention, those of ordinary skill can devise variations of the present invention without departing from the scope of the invention. Accordingly, it is not intended that the invention be limited except as by the appended claims.

1. A pole adaptor, adapted to releasably connect to a pole member and an attachment tool, comprising:
a housing, said housing having a first open end, a second open end, and a mid section;
at least two clip holes configured at the first open end;
a plurality of tab holes configured at said second open end; and
a tapered neck, wherein said tapered neck distinguishes said first open end and said second open end;
wherein said housing is made of a hard non-corrosive material selected from the group consisting of stainless steel, metal, plastic, and polyethylene.

2. The pole adaptor in claim 1, wherein said housing is an elongated cylindrical receptacle.

3. The pole adaptor in claim 1, wherein said first open end being configured to envelope the pole member and securely connect thereto.

4. The pole adaptor of claim 1, wherein said second open end being configured to envelope the attachment tool and securely connect thereto.

5. The pole adaptor of claim 1, wherein said tapered neck distinguishes said first open end and said second open end at said pole adaptor mid-section.

6. The adaptor of claim 1, further comprising a first inner diameter, a first outer diameter, a second inner diameter, and a second outer diameter, wherein said first inner diameter is greater than said second inner diameter.

7. The pole adaptor of claim 1, wherein said housing is adapted to be releasably connected to an attachment tool that is a paint roller, a window cleaning tool, a pool brush, or a pool vacuum tool.

8. A multi-task extension pole adaptor assembly configured to preserve the useful life of a multi-task extension pole comprising:
a cylindrical housing adapted to be releasably connected to a multi-task extension pole and an attachment tool, said cylindrical housing having a first open end, a second open end and a mid section;
wherein said cylindrical housing includes a tapered neck situated between said first open end and said second open end;
wherein said housing is made of a hard non-corrosive material selected from the group consisting of stainless steel, metal, plastic, and polyethylene.

9. The adaptor assembly of claim 8, wherein said housing further comprises two clip holes at said first open end, said clip holes being configured to align with the clip holes on the multi-task extension pole and releasably connect thereto.

10. The adaptor assembly of claim 8, wherein said housing further comprises two clip holes at said first open end, said clip holes being configured to align with two tab locking members on the attachment tool and releasably connect thereto.

11. The adaptor assembly of claim 8, wherein said housing is adapted to be releasably connected to an attachment tool that is a paint roller, a window cleaning tool, a pool brush, or a pool vacuum tool.

12. The adaptor assembly of claim 8, wherein said housing is stainless steel, metal, plastic or polyethylene.

13. The adaptor assembly of claim 8, wherein said first open end clip hole is connected with the multi-task extension pole attachment end by a binding screw.

14. The adaptor assembly of claim 8, wherein said housing is hollow.

15. A pole adaptor comprising:
an elongated cylindrical housing, said housing having a first open end, a second open end, a mid section, at least two clip holes, a plurality of tab holes and a tapered neck;
said first open end adapted to be releasably connected to a multi-task extension pole;
said second open end adapted to be releasably connected to an attachment tool;
said tapered neck being located at said mid section distinguishes said first open end and said second open end;
said mid section being located at a predetermined distance at about mid point between said first open end and said second open end;
said clip holes being positioned to align with clip holes in a multi-task extension pole to be firmly connected to thereto by a binding screw;
said tab holes being positioned to and aligned with tabs on an attachment tool to be firmly and releasably connected by compressing the tabs into the tab holes;
wherein said housing is made of a hard non-corrosive material selected from the group consisting of stainless steel, metal, plastic, and polyethylene.

16. The pole adaptor of claim 15, wherein said housing is hollow.

17. The pole adaptor of claim 15, wherein said housing is adapted to be releasably connected to an attachment tool that is a paint roller, a window cleaning tool, a pool brush, or a pool vacuum tool.

18. The pole adaptor of claim 15, wherein said material is stainless, metal, plastic or polyethylene.

19. The pole adaptor of claim 15, further comprising a first outer diameter, a first inner diameter, a first longitudinal edge-, a second outer diameter, a second inner diameter, and a second longitudinal edge wherein said first inner diameter is greater than said second inner diameter; said first longitudinal edge is longer than said second longitudinal edge.

20. The pole adaptor of claim 19, wherein said longitudinal edge is equal to the combined length of said first longitudinal edge and said second longitudinal edge.
